(19) United States
(12) Patent Application Publication
(10) Pub. No.: US 2026/0350127 A1
(43) Pub. Date: Nov. 5, 2026

(54) INTRINSIC INPUT RHYTHM FOR ENHANCING SECURITY AUTHENTICATION FACTORS

(71) Applicant: T-Mobile USA, Inc., Bellevue, WA (US)

(72) Inventor: Matthew John Starzec, Leesburg, VA (US)

(21) Appl. No.: 19/197,946

(22) Filed: May 2, 2025

(51) Int. Cl. G06F 21/31

(52) U.S. Cl. CPC G06F 21/316

(57) ABSTRACT

Evaluating both alphanumeric password inputs and intrinsic keystroke timings (timing characteristics naturally produced as the password is entered) enhances security by enabling multi-factor authentication in one input step. A password input interface captures a sequence of alphanumeric characters along with the intrinsic input rhythm, generating evaluation data that includes both elements. This evaluation data is transmitted to an authentication service, which compares it to stored credentials for which authenticated access may be granted. Authentication is granted when both the password and the intrinsic input rhythm are verified, providing dual-layer protection without relying on multiple steps to collect the authentication inputs.

### BACKGROUND

Passwords are simple to implement and use, but password authentication can be susceptible to various security threats, such as brute-force attacks and phishing. Some systems implement multi-factor authentication (MFA) to increase the security around password use. MFA requires users to present two or more independent credentials from different categories, such as something the user knows (e.g., a password or PIN), something the user has (e.g., a hardware token, smart card, or mobile device), or something the user is (e.g., biometric data such as a fingerprint or facial recognition). For example, a common MFA implementation may require a user to enter a password and then input a one-time code generated by an authenticator app or sent via short message services (SMS), or to use a fingerprint scan in addition to a password.

Certain implementations of MFA introduce several deficiencies and inconveniences, despite the security enhancements. Users may experience delays or frustration when required to retrieve a physical token or mobile device, especially if such items are misplaced or unavailable. SMS-based codes can be intercepted or delayed, and authenticator apps may be inaccessible if a device is lost or out of battery. Biometric systems, while convenient, can be unreliable due to environmental factors or changes in the user's physical characteristics, and may raise privacy concerns. These challenges can lead to poor user experience, increased support costs, and, in some cases, reduced adoption of secure authentication practices.

### BRIEF DESCRIPTION OF THE DRAWINGS

Detailed descriptions of implementations of the present invention will be described and explained through the use of the accompanying drawings.

FIGS. 1A-1B are block diagrams that illustrate example systems for enhanced security authentication using intrinsic rhythms with password character inputs, according to example implementations of the present technology.

FIG. 2 depicts example authentication factors that include password inputs and intrinsic rhythm aspects, according to example implementations of the present technology.

FIG. 3 is a flowchart of an example method for enhanced security authentication using intrinsic rhythms with password character inputs, according to example implementations of the present technology.

FIG. 4 is a block diagram that illustrates an example of a computing system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides a dual-layer authentication solution that leverages both the alphanumeric content of a password and the intrinsic input rhythm—specifically, the timing characteristics of keystrokes as the password is entered. By integrating the natural cadence of password entry as an additional authentication factor, this approach addresses persistent vulnerabilities in conventional password and multi-factor authentication systems. In some examples, the present technology can enhance security without requiring the collection or storage of sensitive biometric data, thereby supporting user privacy. Because the present technology integrates an additional authentication factor intrinsically within the password character input, the present technology can be easily used in combination with further authentication factors (e.g., fingerprint identification, facial recognition) to provide higher-order authentication.

Some existing systems for password authentication are susceptible to brute-force attacks, phishing, and credential theft, while existing multi-factor authentication (MFA) methods, though more secure, often introduce significant user inconvenience. For example, many systems require users to complete multiple steps, such as entering a password on one screen and then being redirected to a separate screen to input a one-time code from an authenticator app or SMS. This multi-step process can be inefficient and frustrating, particularly if the user must retrieve a physical token, access a mobile device, or contend with unreliable biometric systems that may also raise privacy concerns. For instance, biometric MFA methods such as fingerprint or facial recognition, while effective, may feel invasive to users or raise apprehensions about the handling and potential misuse of their uniquely personal data. These challenges can result in user frustration, increased support costs, and reduced adoption of secure authentication practices.

The present technology overcomes these deficiencies by embedding a second authentication factor—the user's intrinsic input rhythm—directly into the password entry process. This enables a one-step, multi-factor authentication experience that enhances security without imposing additional burdens on the user. By requiring both the correct password and matching keystroke behavior, the technology significantly increases resistance to unauthorized access, even if the password itself is compromised. Unlike biometric factors, the rhythm-based authentication factor is derived from the user's interaction with the device rather than from immutable personal characteristics, providing an additional layer of security that is less likely to be perceived as intrusive or privacy-invasive. Furthermore, the use of a rhythm-based factor can be tailored to publicly known patterns, such as the tempo of a familiar tune, further strengthening the authentication process and enabling flexible enrollment options.

In one aspect, an example system comprises a password input interface configured to capture both the sequence of alphanumeric characters and the associated keystroke timing information as a user enters a password. This evaluation data—including both the password and its intrinsic input rhythm—is transmitted to an authentication service, which compares it to stored reference data or credential. Authentication is granted only when both the password and the input rhythm match the stored reference data or credentials, thereby providing robust, user-friendly, and privacy-conscious security.

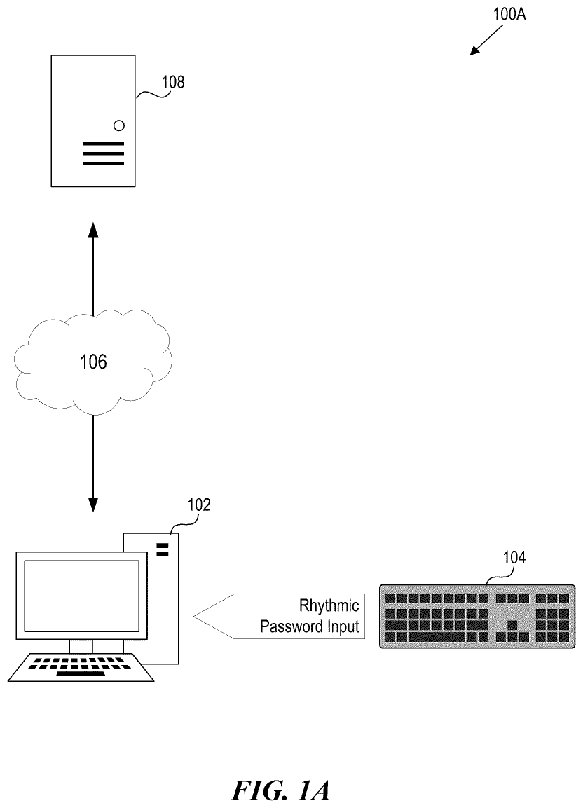

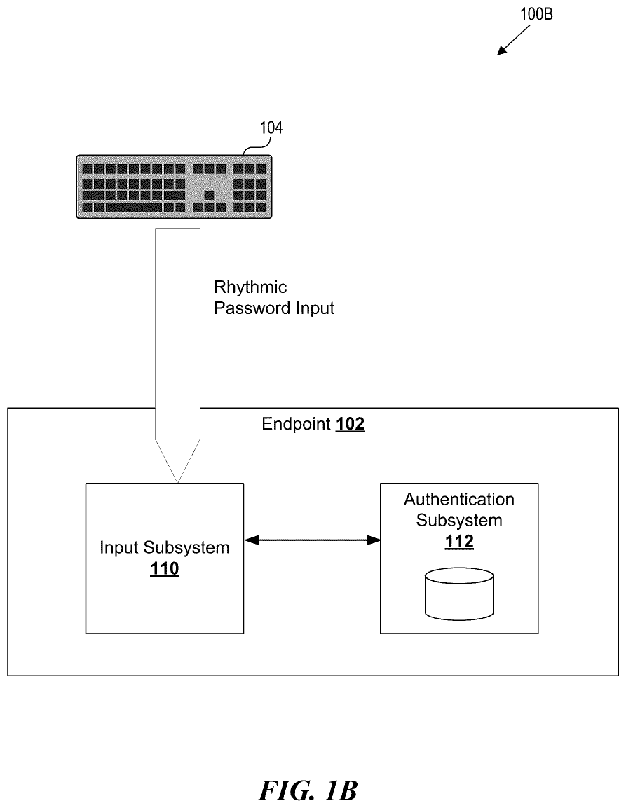

FIGS. 1A-1B are block diagrams that illustrate example systems for enhanced security authentication using intrinsic rhythms with password character inputs. Referring first to FIG. 1A, a system 100A is illustrated for remote authentication using security authentication factors including an intrinsic input rhythm. The system 100A includes a terminal or endpoint 102. The endpoint 102 is a user device comprising an input mechanism 104 that is configured for a user to provide alphanumeric inputs. The endpoint 102 can include, for example, handheld mobile devices (e.g., smartphones, tablets), laptop computers, desktop computers, wearable devices (e.g., smartwatches, fitness trackers), smart televisions, gaming consoles, augmented reality (AR) or virtual reality (VR) headsets, vehicles with onboard computing systems, point-of-sale terminals, kiosks, networked sensors, smart home appliances, Internet of Things (IoT) devices, and/or any other device capable of receiving user input and performing authentication operations.

The input mechanism 104 can include, for example, a physical keyboard, a virtual keyboard displayed on a touchscreen, a touchscreen interface, a stylus, a mouse, a trackpad, a voice input system, a gesture recognition system, or any other mechanism capable of providing alphanumeric or other user inputs to the endpoint 102.

In the remote authentication depicted with system 100A, the endpoint 102 is coupled to a network 106 that the endpoint 102 uses to access remote content, such as webpages, shared network files, and/or the like, from a remote server (e.g., a web server, an application server, a content server). The endpoint 102 can be coupled to the network 106 via a wired connection (e.g., Ethernet, USB), or a wireless connection (e.g., local area network (LAN), Wi-Fi, Bluetooth, near-field communication (NFC), cellular telecommunications network, satellite link, mesh network, or other suitable communication protocols).

The system 100A further includes an authentication server 108. The authentication server 108 verifies credentials or password information provided by clients to determine whether authenticated access to remote content should be allowed for the clients. In the illustrated example, the authentication server 108 can evaluate password inputs provided by the endpoint 102 (via a user's inputs using the input mechanism 104) to determine whether the endpoint's user can access certain content. The authentication server 108 can be implemented as a standalone server, integrated with a content, application, or web server, deployed as a cloud-based authentication service, operated by a federated identity provider (e.g., SSO, OAuth, SAML), hosted on-premises, deployed at the network edge, or distributed across multiple nodes or services. In examples, the authentication server 108 can be integrated into a content server, application server, web server, and/or the like that provides the content. In other examples, the authentication server 108 can be separate from the content/application/web server, or can be integrated into a gateway associated with the content/application/web server, or otherwise be coupled to the content/application/web server to provide security assertions for whether authenticated access should be granted. In some examples, the authentication server 108 can be operated by a security or authentication provider or entity that is different from an owner of the content/application/web server.

In some implementations, the authentication server 108 maintains stored credential data for one or more users. The stored credential data can include, for each user, a reference alphanumeric character string and an associated reference input rhythm. The reference input rhythm may be represented in a variety of forms, including but not limited to, a sequence of time intervals, a binary length characteristic for each character (e.g., short/long, dot/dash), a signature derived from the overall timing pattern, a frequency spectra representation, and/or the like.

The stored credential data may be established in a number of ways. In some examples, a user may generate an alphanumeric character string and provide one or more input samples, with the authentication server 108 capturing the corresponding input rhythm during an enrollment or registration process. The user can provide these credentials using the endpoint 102 at a previous point in time. In other examples, an administrator or another authorized user may define the reference alphanumeric character string and identify or input the corresponding reference input rhythm on behalf of the user. In some implementations, the reference input rhythm may be based on a publicly known rhythmic pattern, such as the tempo of a song or a predefined cadence, which is associated with the reference alphanumeric character string. The user (or another authorized user) can identify by name a song, tune, beat, and/or the like from which the required input rhythm required for a generated alphanumeric character string can be derived.

The authentication server 108 may store the reference data in a secure manner, such as by hashing or encrypting the alphanumeric character string and/or the input rhythm, to protect against unauthorized access or disclosure. In some implementations, the reference input rhythm is not stored as a separate data element, but is instead integrated into the storage of the alphanumeric character string itself; for example, the input rhythm may be used to modulate, hash, or encrypt the character string such that the resulting stored value inherently encodes both the password and its associated input rhythm. As a result, when a password is later asserted, even if the alphanumeric character string is correct, the authentication server 108 will not recognize the input as matching the stored credential unless the input rhythm also corresponds to the reference input rhythm that was used during storage.

According to example implementations, an endpoint 102 can load and provide a password input interface. A user of the endpoint 102 can input a password comprising a sequence of alphanumeric characters via the input mechanism 104 of the endpoint 102. The password input interface that is loaded at the endpoint 102 is configured to determine keystroke timing information that describes the relative timing between the inputting of the individual alphanumeric characters in the password, or generally the intrinsic input rhythm. In some implementations, the password input interface or input subsystem may utilize a buffer to temporarily store keystroke events, with the timing of each event (e.g., keydown or keyup) recorded in the buffer. The keystroke timing information can then be determined by analyzing the timestamps or order of events in the buffer. Alternatively or additionally, keystroke timing information can be determined using event listeners, interrupt-driven input handling, polling mechanisms, and/or the like for capturing the timing of user input events. The endpoint 102 transmits, via the network 106, evaluation data that includes or incorporates both the password information and the keystroke timing information to the authentication server 108. This information can be encrypted or otherwise represented (e.g., in a cryptographic key, in a token, in a signature) for secure transmission over the network 106.

The authentication server 108 can evaluate this information to determine whether the user's password input (with respect to both the alphanumeric character aspect and the intrinsic input rhythm aspect) matches stored credentials for which authenticated access can be granted. Depending on the implementation, the authentication server 108 can explicitly evaluate each of the alphanumeric character aspect and the intrinsic rhythm aspect with corresponding aspects in its stored credentials. In some implementations, the authentication server 108 inherently evaluates the intrinsic rhythm aspect while it evaluates the alphanumeric character aspect of the user's password input. For example, the intrinsic rhythm aspect can be represented as a signature, can control a hashing (locally at the endpoint 102 and/or remotely at the authentication server 108) of the alphanumeric character string, and/or the like. In such examples, an incorrect input rhythm will inherently result in a failed assertion with respect to the alphanumeric character string based on causing an incorrect hashing.

In some implementations, the authentication server 108 provides an indication of a successful or failed factor assertion to the endpoint 102. The authentication server 108 can alternatively or additionally provide this assertion indication to a content/application/web server to cause the content/application/web server to provide content (via the network 106) to the endpoint 102. In some implementations, a successful factor assertion determined by the authentication server 108 in response to the password input and its rhythm aspect only relates to a subset of multiple authentication factors, and the user may be required to provide additional factors such as biometrics or SMS codes.

Turning to FIG. 1B, a system 100B is illustrated for local authentication using security authentication factors including an intrinsic input rhythm. Local authentication can refer to the process of verifying a user's credentials directly on the user's device, without transmitting authentication data to a remote server or service. This is in contrast to remote authentication, where credential verification is performed by a server or service external to the user's device, typically over a network connection. Local authentication can be employed in scenarios such as logging in to and unlocking a personal computer (e.g., a Windows or macOS login screen), accessing a secure area of a mobile device, or authenticating to a local application or encrypted storage volume. In system 100B, the endpoint 102 is configured to perform all authentication operations internally, enabling secure access to local content or functionality without requiring communication with a remote authentication server.

In system 100B, the endpoint 102 comprises an input subsystem 110. The input subsystem 110 is typically implemented as a local software module or component, such as part of the device's operating system, a dedicated authentication application, or a background service responsible for handling user input. In some implementations, the input subsystem 110 may also utilize device drivers or firmware to interface directly with the input mechanism 104, and may leverage hardware-based features for secure input processing. The input subsystem 110 can include or implement a password input interface and is configured to process input received via the input mechanism 104. In particular, the input subsystem 110 determines keystroke timing information or other characteristics that describe the intrinsic input rhythm associated with the user's entry of an alphanumeric character string. The input subsystem 110 may utilize a buffer to temporarily store keystroke events, with timing information derived from the timestamps or sequence of buffered events. Other mechanisms, such as event listeners, interrupt-driven input handling, or polling, may also be used to capture the timing of user input events. The input subsystem 110 may generate evaluation data that includes both the entered character string and the corresponding input rhythm information.

The endpoint 102 further includes an authentication subsystem 112, which is communicably coupled to the input subsystem 110. The authentication subsystem 112 is typically implemented as a local software module or component executing on the endpoint 102, such as part of the device's operating system, a dedicated authentication application, or a security service running in the background. In some implementations, the authentication subsystem 112 may also leverage hardware-based security features, such as a trusted platform module (TPM) or secure enclave, to enhance protection of credential data and authentication operations.

The authentication subsystem 112 is configured to receive the evaluation data from the input subsystem 110 and to determine whether the user should be granted authenticated access to local content or functionality. The authentication subsystem 112 can compare the received character string and input rhythm information to locally stored credential data, which may include a reference alphanumeric character string and a reference input rhythm, or a value in which the input rhythm is integrated with the character string as described above. In some implementations, the authentication subsystem 112 may perform cryptographic operations, such as hashing or encryption, using both the character string and the input rhythm, and may determine authentication success based on whether the evaluation data matches the stored credential data.

In this manner, system 100B enables secure, dual-layer authentication entirely within the endpoint 102, without reliance on network connectivity or external authentication services. This local architecture can be advantageous in scenarios where network access is unavailable, where low-latency authentication is desired, or where user credentials are intended to remain confined to the user's device.

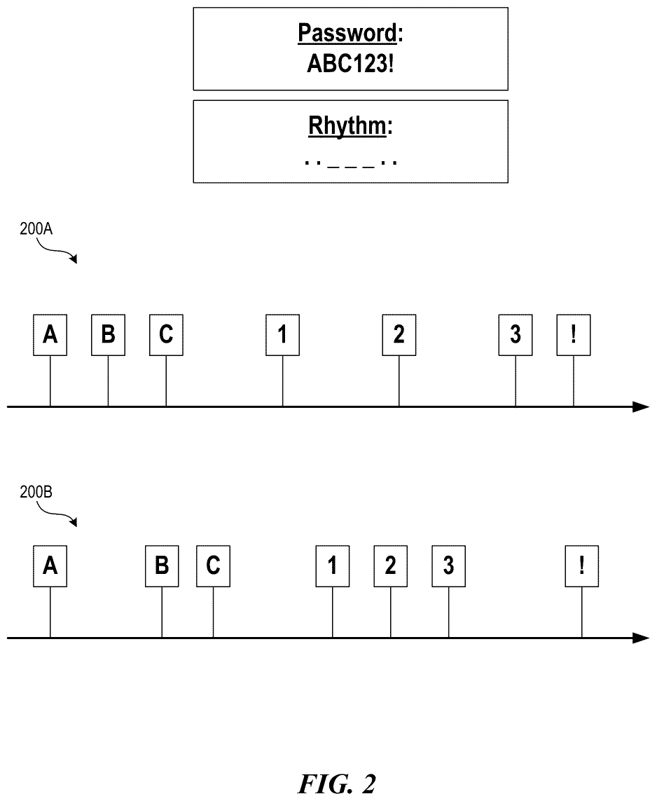

FIG. 2 depicts examples of password input with intrinsic input rhythms, which can be evaluated as an authentication factor. In the illustrated example, a stored credential includes a password that is an alphanumeric character string “ABC123!” and an input rhythm that is represented as “. . _ _ _ . .”, where each dot (“.”) represents a short input and each dash (“_”) represents a long input. The rhythm thus specifies a sequence of binary short/long durations corresponding to each character of the password, akin to Morse code or other binary rhythmic patterns. It should be understood that this Morse code-style short/long rhythm representation is merely exemplary, and a wide variety of other rhythm representations may be used. For example, the credential or reference rhythm may be represented using a musical notation style (e.g., eighth notes, quarter notes, half notes, whole notes) that encodes varying durations for each character input. Other possible representations include numerical values specifying the duration (in milliseconds or other time units) for each character, multi-level encodings (for multiple timing categories such as short, medium, long), coefficients for a frequency spectrum or Fourier transform, and/or the like.

The illustrated example includes two example password inputs, a first input 200A and a second input 200B. FIG. 2 depicts each of the first input 200A and the second input 200B along a horizontal axis representing time. In each example, the individual characters of the password (“A”, “B”, “C”, “1”, “2”, “3”, “!”) are spaced along the time axis to depict a user's timing of each keystroke event relative to the specified rhythm.

Input 200A illustrates a correct input, in which the user enters the password “ABC123!” with the timing of each character input matching the specified rhythm. That is, the intervals between keystrokes for each character correspond to the short or long durations indicated by the rhythm pattern. For example, the first two characters (“A” and “B”) are entered with short intervals, the next three characters (“C”, “1”, “2”) are entered with long intervals, and the final two characters (“3”, “!”) are entered with short intervals. The alignment of the character inputs with the rhythm pattern in 200A represents a successful assertion of both the password and the intrinsic input rhythm.

Input 200B illustrates an incorrect input, in which the user enters the same password “ABC123!” but with a timing pattern that does not correspond to the specified reference rhythm. In this example, the sequence of intervals between character inputs is “_ . _ . _ .”, meaning the first character (“A”) is entered with a long interval, the second character (“B”) with a short interval, the third character (“C”) with a long interval, the fourth and fifth characters (“1” and “2”) with short intervals, the sixth character (“3”) with a long interval, and the final character (“!”) with a short interval. This pattern deviates from the reference rhythm “. . _ _ _ . .” in several positions: for example, the first character should be entered with a short interval but is instead entered with a long interval, and the third character should be entered with a long interval, which is correct, but the subsequent intervals do not consistently match the required sequence. As a result, even though the alphanumeric character string is correct, the input rhythm does not match the reference rhythm, and the input would not be recognized as a valid authentication attempt by the system.

The illustrated example of FIG. 2 thus demonstrates that, in accordance with the present technology, successful authentication requires not only the correct sequence of password characters but also the correct timing or rhythm of input, as defined by the reference rhythm pattern. This multi-layer (but single-step) authentication enhances security by making it more difficult for an unauthorized user to successfully replicate both the password and the associated input rhythm.

Implementations herein are disclosed with respect to intrinsic input rhythms and keystroke timings. In some implementations, other keystroke information or behaviors can be used as additional (or alternative) authentication factors. For instance, alternative to or in addition to keystroke timing, certain implementations can incorporate keystroke pressure or force, identification of which fingers are used for certain keystrokes, and/or the like.

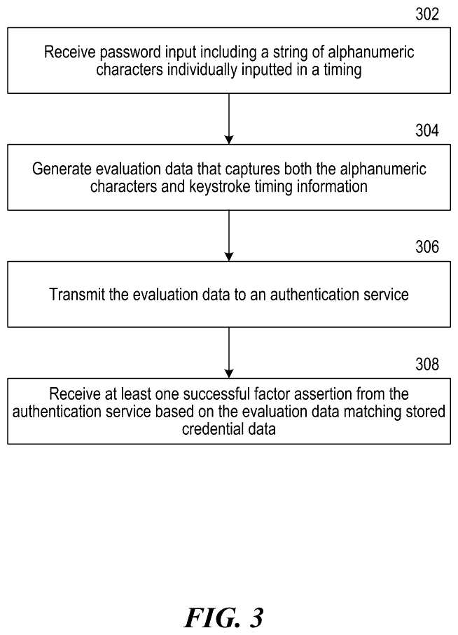

FIG. 3 is a flowchart including example operations for performing multi-layer authentication using both password content and intrinsic input rhythm as authentication factors. The illustrated operations can be performed by a system such as an endpoint device in cooperation with an authentication service or server as described in connection with FIGS. 1A and 1B. The authentication service may be implemented as a remote authentication server accessible over a network, or as a local authentication module within the same system, with communication occurring via an internal communication path. The authenticated access may comprise access to remote content or local access to the system, depending on the implementation.

At 302, the system receives password input including a string of alphanumeric characters individually inputted in a timing. In this stage, a user provides a password via an input mechanism, such as a physical or virtual keyboard, touchscreen, or other input device. The system captures not only the sequence of alphanumeric characters but also the timing information associated with each character input, such as the intervals between keystrokes or the duration of each key press. This timing information may be captured using event listeners, input buffers, or other mechanisms capable of recording the temporal characteristics of the input sequence.

At 304, the system generates evaluation data that captures both the alphanumeric characters and keystroke timing information. In this operation, the system combines the entered password string with the corresponding timing data to form a composite data structure or record. The keystroke timing information may be represented in various forms, including a binary length characteristic (e.g., short/long) for each character, an array of time intervals, or other digital encodings. The evaluation data may include, for example, an array of time intervals, a sequence of duration codes, or another digital representation that encodes the intrinsic input rhythm alongside the password content. This data may be formatted, encrypted, or otherwise processed—such as being modified based on the keystroke timing information—to prepare it for secure transmission and subsequent authentication.

In some implementations, the keystroke timing information is included in the evaluation data and transmitted to the authentication service for direct evaluation. In other implementations, the keystroke timing information is used locally by the system to encode, hash, modulate, encrypt, or otherwise modify the password string, such that the evaluation data comprises only the modified password string, without separately transmitting the keystroke timing information. This flexibility allows the system to support a variety of security and privacy models, including those in which the timing information is not exposed outside the originating device.

At 306, the system transmits the evaluation data to an authentication service. The evaluation data, which includes both the password and the associated keystroke timing information, is sent over a network connection to a remote authentication server or service, or via an internal communication path to a local authentication module. The transmission may be secured using encryption or other protective measures to ensure the confidentiality and integrity of the authentication data during transit.

At 308, the system receives at least one successful factor assertion from the authentication service based on the evaluation data matching stored credential data. In this stage, the authentication service compares the received evaluation data to stored reference credentials, which may include both a reference password and a reference input rhythm. The authentication service may use the keystroke timing information to generate hashed data, which is then compared against hashed versions of the reference alphanumeric character string and the reference keystroke timing. If the keystroke timing information is explicitly received (e.g., not incorporated into the character string), the authentication service may compare it directly to stored reference timing information, or may use it to encode, hash, modulate, or otherwise process the received password string for comparison against a stored reference value. In some implementations, the authentication service may generate hashed data using the keystroke timing information and compare it against hashed versions of the reference alphanumeric character string and the reference keystroke timing. In some implementations, the reference keystroke timing may be generated and stored based on an identification of a publicly known rhythmic pattern, such as the tempo of a song or a predefined cadence, in connection with defining the reference alphanumeric character string.

If the evaluation data matches the stored credentials according to one or more authentication factors, the authentication service generates an assertion indicating successful authentication. This assertion may be used by the system to grant access to protected content, resources, or functionality, or to proceed with additional authentication steps if required (e.g., further authentication factors such as biometrics). In various implementations, the authentication service may return the assertion to the originating system, transmit the assertion to a content server or application server to enable access, forward the assertion to downstream authentication or authorization systems (such as in federated identity or single sign-on scenarios), generate a token for use by other services, or perform other actions such as logging, auditing, or triggering further authentication processes. If the evaluation data does not match the stored credentials, the authentication service generates an assertion indicating failed authentication, which may similarly be returned to the originating system, sent to a content or application server, or used to trigger additional security measures or user notifications.

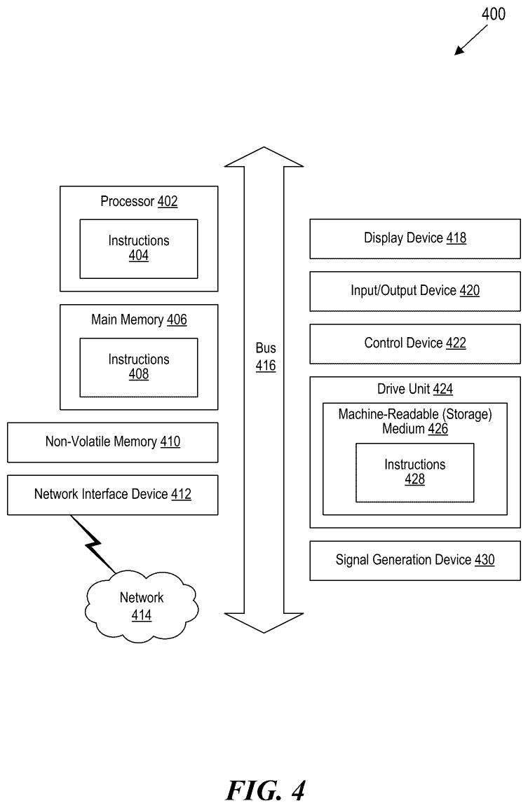

FIG. 4 is a block diagram that illustrates an example of a computing system 400 in which at least some operations described herein can be implemented. As shown, the computing system 400 can include: one or more processors 402, main memory 406, non-volatile memory 410, a network interface device 412, a video display device 418, an input/output device 420, a control device 422 (e.g., keyboard and pointing device), a drive unit 424 that includes a machine-readable (storage) medium 426, and a signal generation device 430 that are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computing system 400 is intended to illustrate a hardware device on which components illustrated or described relative to the examples of the figures and any other components described in this specification can be implemented.

The computing system 400 can take any suitable physical form. For example, the computing system 400 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 400. In some implementations, the computing system 400 can be an embedded computer system, a system-on-chip (SOC), a single-board computer system (SBC), or a distributed system such as a mesh of computer systems, or it can include one or more cloud components in one or more networks. Where appropriate, one or more computer systems 400 can perform operations in real time, in near real time, or in batch mode.

The network interface device 412 enables the computing system 400 to mediate data in a network 414 with an entity that is external to the computing system 400 through any communication protocol supported by the computing system 400 and the external entity. Examples of the network interface device 412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 406, non-volatile memory 410, machine-readable medium 426) can be local, remote, or distributed. Although shown as a single medium, the machine-readable medium 426 can include multiple media (e.g., a centralized/distributed database and/or associated caches and servers) that store one or more sets of instructions 428. The machine-readable medium 426 can include any medium that is capable of storing, encoding, or carrying a set of instructions for execution by the computing system 400. The machine-readable medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computing system 400 to perform operations to execute elements involving the various aspects of the disclosure.

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A system for enhanced security authentication, the system comprising:
at least one processor; and
at least one memory storing instructions that, when executed by the at least one processor, cause the system to:
configure a password input interface to receive password inputs for authenticated access, the password input interface being communicably coupled to an authentication service that evaluates the password inputs and keystroke timings of the password inputs to determine the authenticated access;
receive, at the password input interface, a password input comprising a sequence of individual alphanumeric characters over time;
determine, at the password input interface, keystroke timing information for the password input, the keystroke timing information capturing a relative timing between the individual alphanumeric characters composing the password input;
transmit, from the password input interface to the authentication service, evaluation data that comprises both: (1) the password input and (2) the keystroke timing information for the password input; and
receive, at the password input interface, an indication of a successful authentication using the password input, based on the authentication service matching the evaluation data with (1) a reference alphanumeric character string and (2) a reference keystroke timing associated with the reference alphanumeric character string, the reference alphanumeric character string and the reference keystroke timing being stored by the authentication service.

2. The system of claim 1, wherein the authentication service is an authentication module locally implemented at the system, wherein the password input interface and the authentication module are communicably coupled via a communication path internal to the system, and wherein the authenticated access comprises local access to the system.

3. The system of claim 1, wherein the authentication service is an authentication server, wherein the password input interface and the authentication service are communicably coupled via a network, and wherein the authenticated access comprises access to remote content.

4. The system of claim 1, wherein the evaluation data that comprises both the password input and the keystroke timing information is encrypted or modified based on the keystroke timing information prior to being transmitted to the authentication service.

5. The system of claim 1, wherein the keystroke timing information included in the evaluation data is used by the authentication service to generate hashed data that is compared against hashed versions of the reference alphanumeric character string and the reference keystroke timing.

6. The system of claim 1, wherein the instructions further cause the system to:
generate and store the reference keystroke timing for the reference alphanumeric character string at the authentication service based on an identification of a publicly known rhythmic pattern in connection with defining the reference alphanumeric character string.

7. The system of claim 1, wherein the keystroke timing information for the password input is a binary length characteristic for each of the individual alphanumeric characters.

8. A method comprising:
providing, at a local endpoint, a password input interface to receive password inputs for authenticated access, the password input interface being configured to communicate with an authentication service that determines whether to provide the authenticated access in response to the password inputs;
receiving, via the password input interface, a password input comprising a sequence of individual alphanumeric characters over time;
determining, by the local endpoint, keystroke timing information for the password input, the keystroke timing information capturing a relative timing between the individual alphanumeric characters composing the password input;
transmitting, from the local endpoint to the authentication service, evaluation data that comprises both: (1) the password input and (2) the keystroke timing information for the password input; and
providing, at the local endpoint, the authenticated access in response to the password input, based on the authentication service successfully matching the evaluation data with stored credential data.

9. The method of claim 8, wherein the authentication service is an authentication module implemented at the local endpoint, and wherein the authenticated access comprises local access to the local endpoint.

10. The method of claim 8, wherein the authentication service is a remote authentication server to which the local endpoint is communicably coupled via a network.

11. The method of claim 8, wherein the evaluation data that comprises both the password input and the keystroke timing information is encrypted or modified based on the keystroke timing information prior to being transmitted to the authentication service.

12. The method of claim 8, wherein the keystroke timing information included in the evaluation data is used by the authentication service to generate hashed data that the authentication service compares against the stored credential data.

13. The method of claim 8, wherein the stored credential data stored by the authenticated service comprises a reference keystroke timing that is generated based on a prior identification of a publicly known rhythmic pattern.

14. The method of claim 8, wherein the keystroke timing information for the password input is a binary length characteristic for each of the individual alphanumeric characters.

15. At least one non-transitory computer-readable medium storing instructions that, when executed by at least one processor, cause the at least one processor to perform operations comprising:
providing a password input interface to receive password inputs for authenticated access, the password input interface being configured to communicate with an authentication service that determines whether to provide the authenticated access in response to the password inputs;
receiving, via the password input interface, a password input comprising a sequence of individual alphanumeric characters over time;
determining keystroke timing information for the password input;
transmitting, from the password input interface to the authentication service, evaluation data that comprises both: (1) the password input and (2) the keystroke timing information for the password input; and
receiving, from the authentication service, at least one successful factor assertion with respect to a keystroke timing factor based on the authentication service successfully matching the evaluation data with stored credential data.

16. The at least one non-transitory computer-readable medium of claim 15, wherein the authentication service locally implemented at a local endpoint at which the password input interface is provided, and wherein the authenticated access comprises local access to the local endpoint.

17. The at least one non-transitory computer-readable medium of claim 15, wherein the authentication service resides at a remote server to which the password input interface is coupled via a network.

18. The at least one non-transitory computer-readable medium of claim 15, wherein the evaluation data that comprises both the password input and the keystroke timing information is encrypted or modified based on the keystroke timing information prior to being transmitted to the authentication service.

19. The at least one non-transitory computer-readable medium of claim 15, wherein the keystroke timing information included in the evaluation data is used by the authentication service to generate hashed data that is compared against the stored credential data.

20. The at least one non-transitory computer-readable medium of claim 15, wherein the operations further comprise:
deriving a reference keystroke timing included in the stored credential data of the authentication service based on an identification of a publicly known rhythmic pattern.
